(19) United States
(12) Patent Application Publication
(10) Pub. No.: US 2024/0198915 A1
(43) Pub. Date: Jun. 20, 2024

(54) Vehicle Hat Rack

(71) Applicant: Daniel McBride, Gary, TX (US)

(72) Inventor: Daniel McBride, Gary, TX (US)

(21) Appl. No.: 18/542,559

(22) Filed: Dec. 15, 2023

Related U.S. Application Data
(60) Provisional application No. 63/433,392, filed on Dec. 16, 2022.

(51) Int. Cl. B60R 7/10; B60R 7/04

(52) U.S. Cl. CPC B60R 7/10; B60R 7/043

(57) ABSTRACT

The invention includes devices for holding hats in vehicles. For example, the invention includes a unitary body that extends between a first head rest post and a second head rest post, where the unitary body includes two sections that are generally symmetrical around a vertical axis that is located equidistance between the first head rest post and the second head rest post. The unitary body includes a midpoint at the vertical axis, where such midpoint is located above the head rest when the device is installed in a vehicle and where such midpoint can be used to hold a hat.

### CROSS-REFERENCE TO RELATED APPLICATIONS

This application claims the benefit of U.S. Provisional Patent Application Ser. No. 63/433,392, filed Dec. 16, 2022, which is hereby incorporated herein by reference in its entirety.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

The inventor has not made any prior public disclosure of the inventions disclosed herein.

### BACKGROUND OF THE INVENTION

### 1. Field of the Invention

The inventions described herein generally relate to devices for providing the holding of hats, such as cowboy hats, within vehicles.

### 2. Description of Related Art

U. S Application Publication No. 2013/0037672 to Sanchez discloses an automobile headrest hat hook that includes a twist tie or bendable wire material that is mounted on the side of an automobile headrest by wrapping the twist tie or bendable wire material around the post of the headrest. The twist tie or bendable wire material extends upward along the side of the headrest to form a hook for hanging one or more hats. The twist tie or bendable wire can be wrapped in rubber foam to give it grip when tied around the headrest post.

U.S. Patent Application Publication No. 2015/0183379 to Hensley discloses an automobile hat holder that includes two straps that are secured around an automobile headrest. Each strap includes a pocket for respectively receiving a first leg and second leg of the hat holding portion of the hat holder. The hat holding portion of the hat holder connects the first and second legs and extends outwardly from the headrest by way of right angles between the first and second legs and the hat holding portion of the hat holder.

U.S. Patent Publication No. 2019/0009728 to Sharon et al. discloses an automobile head rest hanging hat rack that is formed as a single piece, knock down structure. The hanging hat rack includes a back that is configured to be adjacent to the automobile seat, and a base that is coupled to a lower end of the back and that extends away from the back. The hanging hat rack also includes a hat hanging member that is coupled to the base at a position opposite the position of the coupling of the back to the base. The hat hanging member is configured to be spaced from the automobile seat and further configured to engage the interior of a hat at a position above the hat's sweatband.

In view of the background in this area, there remain needs for improved and/or alternative devices for holding hats within vehicles. The present inventions are addressed to those needs.

### BRIEF SUMMARY OF THE INVENTION

In one aspect, the invention provides an apparatus for holding a hat within a vehicle. The apparatus includes a first end that is configured to connect to a first post of a headrest in an automobile. The apparatus also includes second end that is configured to connect to a second post of a headrest in an automobile. The apparatus further includes a body that extends between the first end and the second end, and where the body has a midpoint that is located above the headrest when the first end is connected to the first post and the second end is connected to the second post.

In another aspect, the invention provides an apparatus for holding a hat within a vehicle that includes a first end that is configured to releasably connect to a first post of a headrest in an automobile, and a second end that is configured to releasably connect to a second post of a headrest in an automobile. The apparats also includes a unitary body that extends from the first end to the second end, and where the unitary body further includes a first body section and a second body section. The first body section and the second body section are generally symmetrical to one another along a vertical axis that is equidistant between the first end and the second end. Each of the first body section and the second body section extends outwardly from the respective first end and second end before turning in an upwards fashion to a midpoint at the vertical axis. The midpoint is located above the headrest when the first end and the second end are connected respectively to the first head rest post and the second head rest post.

In yet another aspect, the invention provides an apparatus for holding a hat within a vehicle that includes a unitary body that extends from a first end that is configured to releasably connect to a first post of a headrest in an automobile to a second end that is configured to releasably connect to a second post of the headrest. The unitary body occupies a generally symmetrical shape along a vertical axis that extends equidistance between the first end and the second end. The unitary body occupies a midpoint located where the unitary body crosses the vertical axis. The midpoint is located above the headrest when the first end and the second ends are connected to the respective first and second posts of the headrest.

### BRIEF DESCRIPTION OF THE SEVERAL VIEWS OF THE DRAWINGS

FIG. 1 depicts an upper-left-rear perspective view of an illustrative embodiment of the invention.

FIG. 2 depicts an upper left rear perspective exploded view of an illustrative embodiment of the invention (with the hat removed).

FIG. 3 depicts an upper left rear perspective exploded view of an illustrative embodiment of the invention (with the hat in place).

### DETAILED DESCRIPTION OF THE INVENTION

For the purposes of promoting an understanding of the principles of the invention, reference will now be made to certain embodiments thereof and specific language will be used to describe the same. It will nevertheless be understood that no limitation of the scope of the invention is thereby intended, such alterations, further modifications and further applications of the principles of the invention as described herein being contemplated as would normally occur to one skilled in the art to which the invention relates.

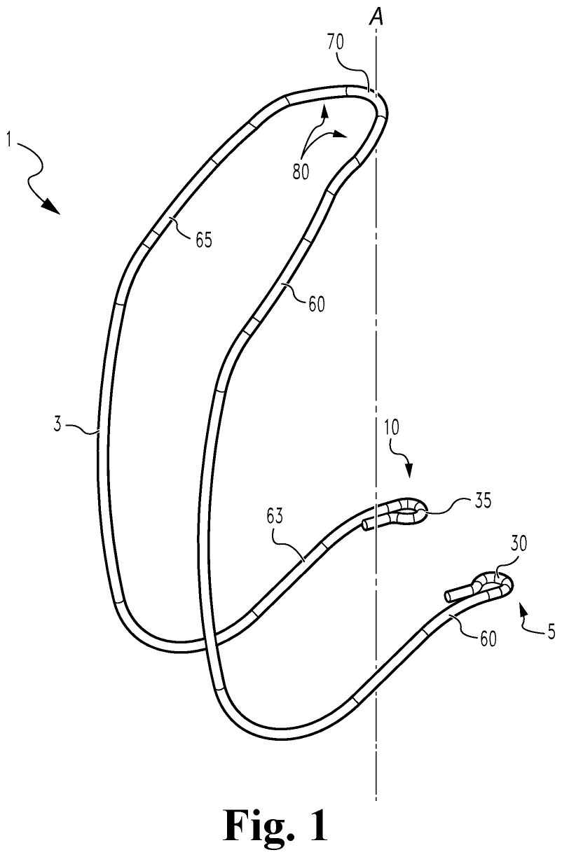

Depicted in FIGS. 1-3 is an illustrative apparatus 1 for holding a hat within a vehicle. The apparatus 1 can include a body 3 that extends from a first end 5 to a second end 10. The first end 5 of the body 3 is configured to connect to the first post 25 of an automotive headrest 20 and the second end 10 of the body 3 is configured to connect to the second post 27 of the automotive head rest 20.

The body 3 can be unitary, such as can be formed by extruding a piece of metal that has a circular cross section, followed by bending such body 3 in a configuration set forth herein. In other embodiments, however, the body can be non-unitary and can be formed of other materials, such as plastics, etc. Illustratively, the body 3 can include a unitary wire formed of a metal, such as aluminum, steel, or the like. It is desirable, however, for the body 3 to be stiff enough to hold its shape under the weight of a heavy cowboy hat 50 under the forces caused by a moving vehicle and its occupants.

The first end 5 and the second end 10 of the body 3 can be configured in a manner so as to releasably connect to the respective first 25 and second 27 headrest posts. Any suitable releasable connection can be used to attach the apparatus 1 to the first 25 and second 27 head rest posts, such as expandable eyelets 30, 35 that can be formed in the first 5 and second 10 ends of the body 3. Such eyelets can be illustratively formed by bending the first 5 and second 10 ends of the unitary body into eyelets 30, 35 that have an open end that permits passage of the first 25 and second 27 posts of the headrest 20. Alternatively, however, such eyelets 30, 35 can be enclosed, such as by occupying a circular shape, thereby permitting the first 25 and second 27 posts of the headrest to slide through each eyelet 30, 35 by removing the headrest 20 from the car seat 40 and then reinstalling the head rest after sliding the first 25 and second 27 posts of the headrest 20 through each eyelet 25, 30. In yet other embodiments, any suitable means can be used to attach the unitary body 3 to the headrest or the seat back 40.

The unitary body 3 can include a first body section 60 and a second body section 65. The first body section 60 and the second body section 65 can be generally symmetrical about a vertical axis A that is equidistant from the first 5 and second 10 end of the unitary body 3 (or the first 25 and second 27 post of the headrest 20, which is roughly the same distance). The first body section 60 and the second body section 65 can extend outwardly from the back of the headrest 20 or the back of the seat 40 before turning upwardly to meet at a midpoint 70 in the body 3. The body 3 can be configured such that the midpoint 70 resides above the headrest 20 when the apparatus 1 is installed in an automobile. Illustratively, the midpoint 20 is located toward the back of the top of the headrest 75 and is a distance D of approximately one (1) to two (2) inches above the top of the headrest 20, with a distance of two (2) inches providing a desirable result. Such distance can vary, however, such as by the make and model of the automobile, but illustratively, such distance D is established to permit the hat 50 to easily slide from the seat occupant's head onto the headrest and vice-versa, thereby providing tactical efficiency for placing and removing the hat 50 from the apparatus.

As depicted in FIGS. 1 and 2, the first body section 60 and the second body section 65 provide an elongated “C” shape when viewed from the right or left side of the apparatus 1. This elongated “C” shape helps provide support to a hat 50 as it is resting on the apparatus 1. This elongated “C” shape also permits the hat 50 to easily slide off of the apparatus 1 and onto an occupant's head so as to not hinder the removal of a hat from the apparatus 1 such as by way of an edge or protrusion that would catch the hat during removal. In fact, the apparatus can provide a benefit to certain hat wearers, such as law enforcement, because the apparatus 1 provides the vehicle occupant with the ability to quickly and smoothly remove and replace the hat 50 in the course of work.

The body 3 can include an arcuate section 80 that can hold the inner part of the hat 50 when the hat 50 is being held by the apparatus 1. In illustrative embodiments, the arcuate section 80 can generally mirror the interior part of the hat 50 that rests on the forehead of the seat occupant, such as where the sweat band of the hat 50 may be. Additionally, the body 3 of the apparatus 1 can provide additional support for the hat 50 while the hat is being held by the hat rack 1. The arcuate section 80 can also be formed to generally match the interior part of a specific type of hat, such as a cowboy hat 50. However, the invention is not limited to cowboy style hats and can be configured for use with all types of hats, including ball caps, law enforcement hats, etc., in addition to cowboy style hats.

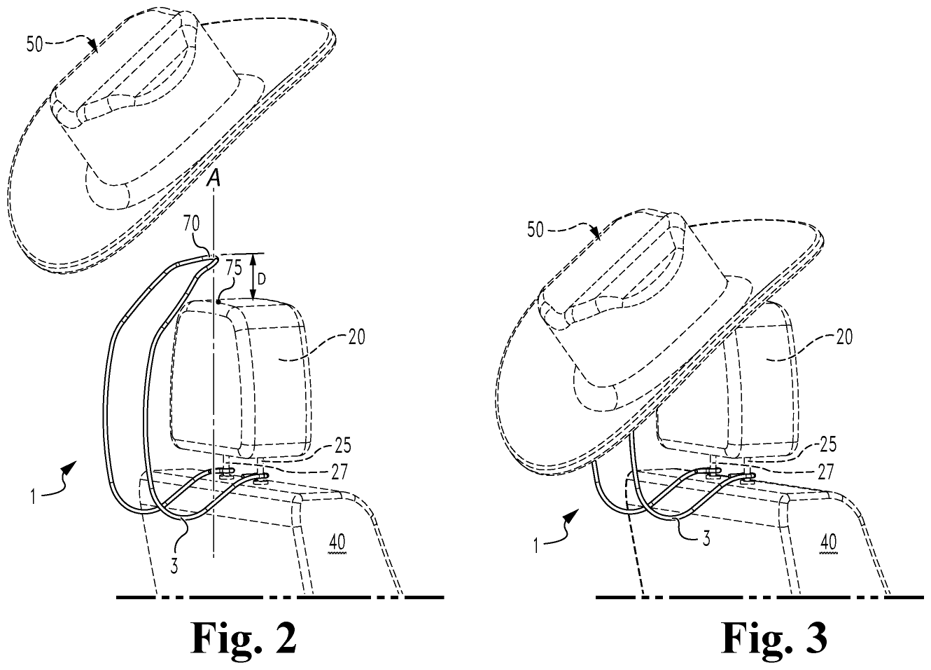

FIG. 1 depicts an embodiment of an apparatus 1 of the invention, FIG. 2 depicts such apparatus 1 located in a vehicle with a hat 50 exploded therefrom, and FIG. 3 shows the apparatus 1 located in a vehicle with the hat 50 resting thereon.

All publications cited herein are hereby incorporated by reference in their entirety as if each had been individually incorporated by reference and fully set forth.

While the invention has been illustrated and described in detail in the drawings and foregoing description, the same is to be considered as illustrative and not restrictive in character, it being understood that only the preferred embodiments have been shown and described and that all changes and modifications that come within the spirit of the invention are desired to be protected.

1. An apparatus for holding a hat within a vehicle, comprising:
a first end, wherein said first end is configured to connect to a first post of a headrest in an automobile;
a second end, wherein said second end is configured to connect to a second post of a headrest in an automobile;
a body, wherein said body extends between said first end and said second end, and wherein said body has a midpoint, whereby said midpoint is located above said headrest when said first end is connected to said first post and said second end is connected to said second post.

2. The apparatus of claim 1, wherein said body is further comprised of an arcuate section that extends along said body outwardly from said midpoint located above said headrest.

3. The apparatus of claim 2, wherein said arcuate section is configured so as to receive a cowboy hat.

4. The apparatus of claim 3, wherein said body is comprised of a metal material.

5. The apparatus of claim 1, wherein said body is unitary.

6. The apparatus of claim 1, wherein said first end and said second end are each configured to be releasably connected to said first post and said second post of said head rest.

7. The apparatus of claim 1, wherein said midpoint is located two inches above said headrest when said first end is connected to said first head rest post and said second end is connected to said second head rest post.

8. An apparatus for holding a hat within a vehicle, comprising:
a first end, wherein said first end is configured to releasably connect to a first post of a headrest in an automobile;
a second end, wherein said second end is configured to releasably connect to a second post of a headrest in an automobile;
a unitary body extending from said first end to said second end, wherein said unitary body is further comprised of first body section and a second body section, wherein said first body section and said second body section are generally symmetrical to one another along a vertical axis that is equidistant between said first end and said second end;
wherein each of said first body section and said second body section extends outwardly from said respective first end and said second end before turning in a upwards fashion to a midpoint at said vertical axis, wherein said midpoint is located above said headrest when said first end and said second end are connected respectively to said first head rest post and said second head rest post.

9. The apparatus of claim 8, wherein said unitary body comprises a metal material.

10. The apparatus of claim 8, wherein said unitary body occupies an arcuate section that extends outwardly from said midpoint.

11. The apparatus of claim 10, wherein said arcuate section is configured to hold a hat.

12. The apparatus of claim 8, wherein said unitary body comprises a circular cross section.

13. The apparatus of claim 8, wherein said unitary body comprises a wire.

14. An apparatus for holding a hat within a vehicle, comprising:
a unitary body that extends from a first end, said first end configured to releasably connect to a first post of a headrest in an automobile, to a second end, said second end configured to releasably connect to a second post of said headrest;
wherein said unitary body occupies a generally symmetrical shape along a vertical axis that extends equidistance between said first end and said second end;
wherein said unitary body occupies a midpoint located where said unitary body crosses said vertical axis;
wherein said midpoint is located above said headrest when said first end and said second ends are connected to said respective first and second posts of said headrest.

15. The apparatus of claim 14, wherein said unitary body includes a cross section, wherein said cross section is generally cylindrical.

16. The apparatus of claim 14, wherein said unitary body includes an arcuate shape extending outward from said midpoint along said unitary body.
